(19) United States
(12) Patent Application Publication
(10) Pub. No.: US 2025/0249913 A1
(43) Pub. Date: Aug. 7, 2025

(54) METHOD AND DEVICE FOR RECOGNIZING A HANDS-OFF STATE AT A STEERING WHEEL OF A VEHICLE

(71) Applicant: Volkswagen Aktiengesellschaft, Wolfsburg (DE)

(72) Inventors: Jonas Kaste, Braunschweig (DE); Felix Stahl, Braunschweig (DE); Felix Kallmeyer, Wolfsburg (DE)

(21) Appl. No.: 19/044,406

(22) Filed: Feb. 3, 2025

(30) Foreign Application Priority Data
Feb. 6, 2024 (DE) 102024201064.2

(51) Int. Cl. B60W 40/08; B60W 50/00; G06N 3/044

(52) U.S. Cl. CPC B60W 40/08; G06N 3/044; B60W 2050/0028; B60W 2420/24; B60W 2510/202; B60W 2540/223

(57) ABSTRACT

A method and device for recognizing a hands-off state at a vehicle steering wheel. At least one steering variable is detected at the steering wheel and supplied as input data to a trained machine learning model. The model comprises a trained main model and a preceding trained adapter model. The adapter model determines general input data from specific input data. The main model recognizes the hands-off state from the general input data and outputs associated state information. This approach allows adapting the machine learning model to various usage conditions with reduced effort by only modifying the adapter model while keeping the main model fixed.

### RELATED APPLICATIONS

The present application claims priority to German Patent App. No. DE102024201064.2, filed Feb. 6, 2024, the contents of which are incorporated by reference in their entirety herein.

### TECHNICAL FIELD

The present disclosure relates to a method and a device for detecting a hands-off state at a vehicle steering wheel.

### BACKGROUND

Sensors, such as capacitive steering wheels, are used in vehicles for monitoring driver activity. Such steering wheels recognize touch or non-touch (“hands-off”) conditions by the driver using a capacitive sensor. The sensor's output is transmitted to utilizing functions, such as longitudinal and/or lateral guidance assistance systems. Driver activity and attention can be inferred from hands touching the steering wheel. In some embodiments, the system may advise the driver to place their hands on the steering wheel if it detects that the hands were not on the steering wheel for a predefined time during lateral guidance.

To reduce costs associated with capacitive sensors in steering wheels, methods have been developed to monitor driver activity using machine learning models, particularly artificial neural networks, based on the torque (hand moment) detected at the steering wheel. An example of such a method is described in DE 10 2019 211 016 A1.

A significant challenge in steering torque-based detection is identifying the driver-induced steering moment within the measured (noisy) steering torque. Several factors contribute to noisy steering torque, including sensor position, steering system friction intensity, road feedback from surface irregularities, dead weight of the steering wheel/steering system, and steering wheel vibration caused by assistance functions. The sensor position is particularly problematic, as it typically forms part of the steering gear or steering assistance system, creating a torsionally vibrating system due to steering column elasticities and steering wheel momentum, which complicates precise measurement of driver-induced moment.

Furthermore, the characteristics used for hands-off recognition in the measured steering torque can vary due to external influences. These influences include temperature, vehicle loading state, presence of a trailer, tire type and/or condition, changes in the steering system over its service life, and roadway grade, slope, or pitch.

Additionally, vehicle-specific characteristics influence hands-off recognition. Consequently, different vehicle platforms and chassis configurations (e.g., all-wheel drive vs. front-wheel drive) exhibit distinct characteristics, requiring the machine learning model to learn different patterns. This necessitates training a dedicated machine learning model for each vehicle class or chassis configuration. Generating and utilizing extensive volumes of corresponding training data for this purpose results in significant effort and costs.

### SUMMARY

Aspects of the present disclosure are directed to improving methods and devices for recognizing a hands-off state at a steering wheel of a vehicle.

According to some aspects of the present disclosure, the described functionality is achieved by the independent claims of the present application, as detailed below. Additional aspects are disclosed in the dependent claims, the description, and the drawings. Features, advantages, and possible implementations described in connection with one subject of the independent claims should be understood as applicable, at least analogously, to other independent claims, as well as any combination of independent and dependent claims.

In some examples, a method is disclosed for recognizing a hands-off state at a steering wheel of a vehicle. The method involves detecting at least one steering variable at the steering wheel and supplying the detected steering variable to a trained machine learning model as input data. The machine learning model is trained to recognize a hands-off state based on at least the detected steering variable and to output an associated state variable as output data. The trained machine learning model comprises a trained main model and a trained adapter model preceding the main model. The main model is trained to recognize the hands-off state based on general input data, while the adapter model is trained to determine the general input data based on specific input data.

In some examples, a device is disclosed for recognizing a hands-off state at a steering wheel of a vehicle. The device comprises at least one steering variable sensor designed to detect at least one steering variable at the steering wheel, and a data processing unit. The data processing unit is designed to receive the detected steering variable, provide a trained machine learning model, and supply the detected steering variable to the trained machine learning model as input data. The machine learning model is trained to recognize a hands-off state based on at least the detected steering variable and to output associated state information as output data. The trained machine learning model comprises a trained main model and a trained adapter model preceding the main model. The main model is trained to recognize the hands-off state based on general input data, while the adapter model is trained to determine the general input data based on specific input data.

Further features regarding the design of the device will be apparent from the description of designs of the method. The advantages of the device are in each case the same as with the designs of the method.

Furthermore, a steering system is also created, comprising a device according to one of the described embodiments.

Additionally, a vehicle is created, comprising a steering system according to one of the described embodiments and/or a device according to one of the described embodiments.

### BRIEF DESCRIPTION OF THE DRAWINGS

Aspects of the present disclosure will be described in greater detail hereafter based on preferred exemplary embodiments with reference to the figures. In the drawings:

FIG. 1 shows a schematic representation to illustrate embodiments of the device for recognizing a hands-off state at a steering wheel, according to some aspects of the present disclosure.

FIG. 2 shows a schematic representation to illustrate the machine learning model, according to some aspects of the present disclosure.

FIG. 3 shows a schematic representation to illustrate a training of the adapter model, according to some aspects of the present disclosure.

### DETAILED DESCRIPTION

The present disclosure describes methods and devices that enable adaptation of a trained machine learning model to various usage conditions with reduced effort. A key aspect of the present disclosure is a trained machine learning model comprising a trained main model and a trained adapter model. The main model is trained to recognize the hands-off state based on general input data, while the adapter model is trained to determine general input data from specific input data.

The adapter model transforms specific input data from a specific data domain into a general data domain suitable for the main model. This allows the main model, trained on general input data, to process specific input data more effectively. The main advantage is that the main model can be trained once with a large dataset and remain unmodified, while a suitable adapter model enables its use for specific input data from different domains.

This approach reduces the effort required for training and providing the machine learning model for various usage conditions. The main model only needs to be trained once, with adaptation to other usage conditions occurring exclusively through the adapter model preceding the main model.

A steering variable, particularly relevant to this disclosure, represents or describes the present state of the steering wheel. Typically, it's a torque detected by at least one sensor at the steering wheel. However, it may also be another variable directly or indirectly detected at the steering wheel, such as current at an electric machine. The hands-off state recognition can be based solely on the detected steering variable, particularly torque, or may consider additional steering variables like steering wheel angle or speed. Non-steering wheel variables such as vehicle speed, transverse acceleration, or yaw rate can be considered as context information. Notably, no capacitive sensor is provided at the steering wheel.

The hands-off state recognition may also include recognizing a hands-on state. A hands-off state is defined as when the driver does not touch the steering wheel, while a hands-on state is when the driver touches it. The recognition process may provide a hands-off state signal, which could include a hands-off probability or coded signals for different states. Multiple categories or classes beyond simple “hands-off” and “hands-on” may be distinguished, such as partial contact or gripping with one or both hands.

The machine learning model may comprise one or more neural networks with multiple inner layers. It particularly includes an artificial recurrent neural network that processes input data Xₜ at any point in time and outputs a hands-off probability yₜ in [0,1]: yₜ=p(xₜ|_{x0:t-1}). The recurrent neural network, in particular, has a so-called memory h, in which pieces of information from previous time steps are stored and which can be used for the output during the present time step.

Output data from the trained machine learning module undergoes filtering before being processed by receiving functions like transverse guidance assistance systems. A binary hands-off signal may be provided based on comparing the hands-off probability to a predefined threshold.

During the training phase, the main model is trained in a general data domain using numerous training data pairs, each consisting of steering variable data (particularly torque data) paired with a hands-off state. This training occurs without the adapter model. The training data, typically time series of steering variables detected at the steering wheel, are obtained through test drives or simulators. The training process follows supervised learning methods, as described in DE 10 2019 211 016 A1.

During the adapter model's training phase, it precedes the fully trained main model. The main model remains fixed, with its parameters and weights unchanged during adapter model training. The adapter model is trained using data from a specific domain, comprising pairs of steering variable data (particularly torque data) and corresponding hands-off states. This training dataset can be significantly smaller than that used for the main model. The steering variable data typically consists of time series detected at the steering wheel, obtained through test drives or simulators for the specific domain. Training data provision follows the method described in DE 10 2019 211 016 A1, using supervised learning techniques.

In the training process, the adapter model estimates general input data for the trained main model based on input data from a training sample. The main model then produces a hands-off state output, which is compared to the ground truth from the training data. Any resulting deviation leads to adjustments in the adapter model's parameters and weights only.

The adapter model's output corresponds to the main model's input, with identical structure and dimensions. This relationship can be expressed as |y_{Adapter}|=|X|, where y_{Adapter} represents the adapter model's output data and X represents the main model's input data.

Components of the device, particularly the data processing device, can be designed as a combination of hardware and software, such as program code executed on a microcontroller or microprocessor. Alternatively, parts may be designed as application-specific integrated circuits (ASICs) or field-programmable gate arrays (FPGAs). The data processing unit typically includes at least one computing unit and memory.

In one embodiment, the trained adapter model is selected based on the vehicle model, steering model, vehicle class, or specific vehicle characteristics. This allows the machine learning model to be adapted to the vehicle and its usage conditions with minimal effort. The adapter model can also be trained for specific vehicle models, classes, or characteristics. This approach enables easy adaptation to different vehicle models by simply exchanging the adapter model for a more suitable trained version.

Another embodiment provides the trained main model in hard-coded form, allowing for faster and more resource-efficient execution. For instance, the trained main model might be implemented using an ASIC, with hard-coded parameters and weights that cannot be modified. Adaptation to different usage conditions is then achieved through suitably trained adapter models.

In a further embodiment, the trained adapter model is stored in a dedicated writable non-volatile memory area. This allows the device to be used for various usage conditions, including different vehicle models, classes, or characteristics. For example, a device might have a hard-coded trained main model and a writable memory area for the specific adapter model, enabling customization for particular usage conditions.

The trained main model can be configured as a recurrent neural network, such as a long short-term memory (LSTM) network.

Similarly, the trained adapter model can also be implemented as a recurrent neural network, improving the adaptation from the specific data domain to the general data domain. While it can be configured as an LSTM, the adapter model could alternatively be a fully connected network or a convolutional neural network (CNN).

In one embodiment, at least one piece of context information is detected and/or obtained, which is supplied as input data to the trained adapter model. The trained adapter model takes this context information into consideration when determining the general input data. This approach allows for additional context to be considered, increasing the number of inputs to account for extra context information. This is possible even when the trained main model does not directly consider this additional context information. Context information encompasses characteristics of the situation in which the hands-off state recognition occurs or where steering variable values were detected. Examples include outside temperature, inside temperature, steering wheel vibration, vehicle loading/weight, presence of a trailer or snow chains, road conditions (e.g., cobblestones, potholes), maximum steering interventions, speed bumps, and driver characteristics (e.g., identity, gender, age, weight, hand size). This context information is typically recognized or determined from detected sensor data. Sensors may be provided specifically for detecting context-related data, or such data may be obtained via the vehicle's CAN bus or from other vehicle sensors or controllers.

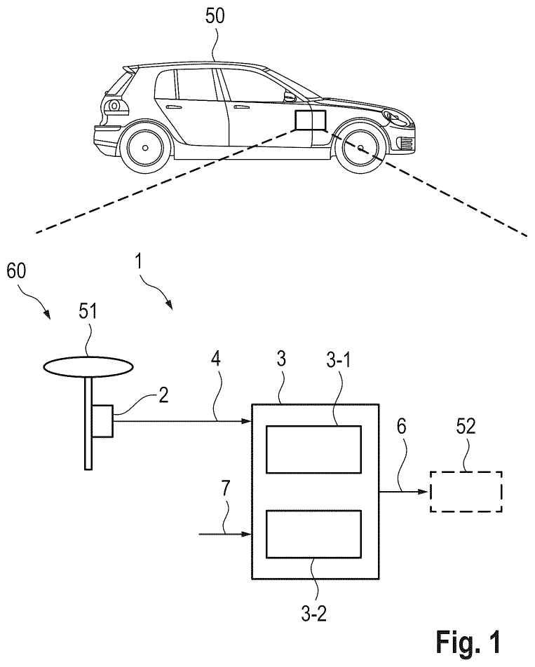

FIG. 1 illustrates a schematic representation of an embodiment of the device 1 for recognizing a hands-off state 6 at a steering wheel 51. The device 1 is typically arranged in a vehicle 50 as part of a steering system 60. This figure helps clarify and explain the method described in the present disclosure.

The device 1 comprises a steering variable sensor 2 and a data processing unit 3. The steering variable sensor 2 is designed to detect a steering variable 4 at the steering wheel 51 of the vehicle 50. For example, the steering variable sensor 2 may be a torque sensor, with the steering variable 4 being torque. Additional steering variable sensors may be provided to detect other steering variables.

The data processing unit 3 includes a computing unit 3-1 and a memory 3-2. The computing unit 3-1 is designed to perform the necessary computations for carrying out the method's measures, accessing data stored in the memory 3-2 as needed.

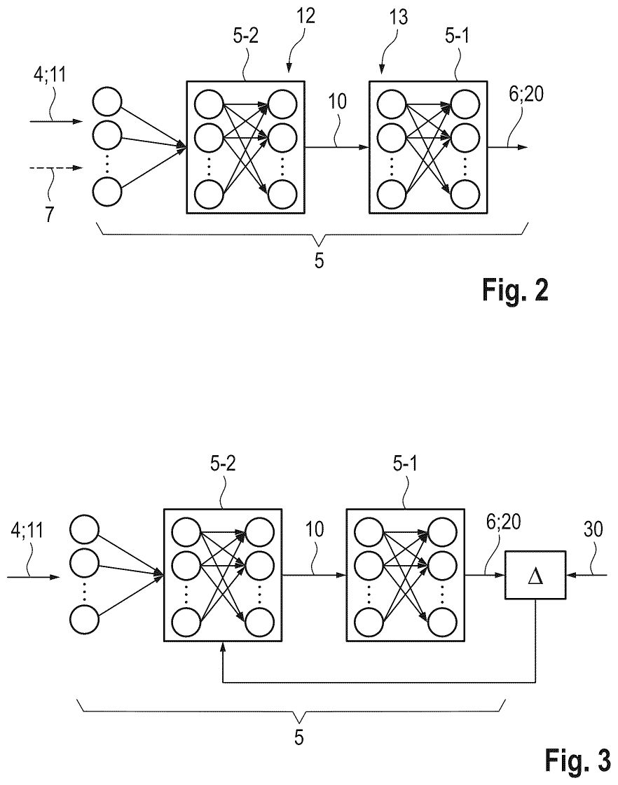

The data processing unit 3 is designed to obtain the detected steering variable(s) 4, provide a trained machine learning model 5 (see FIG. 2), and supply the detected steering variable(s) 4 to the trained machine learning model 5 as input data.

The machine learning model 5 is trained to recognize a hands-off state 6 based on at least the detected steering variable(s) 4, and to output associated state information as output data 20 (FIG. 2).

FIG. 2 schematically illustrates the structure of the trained machine learning model 5. It comprises a trained main model 5-1 and a trained adapter model 5-2 preceding the main model 5-1. The main model 5-1 is trained to recognize the hands-off state 6 based on general input data 10. The adapter model 5-2 is trained to determine, and in particular to estimate, the general input data 10 from specific input data 11. Time-resolved values (time series) of the at least one steering variable 4 are supplied as specific input data 11 to the adapter model 5-2. The adapter model 5-2 then determines the general input data 10, which are supplied to the trained main model 5-1. For this purpose, an output layer 12 of the trained adapter model 5-2 has the same dimension or number of nodes as an input layer 13 of the trained main model 5-1. The trained main model 5-1 recognizes the hands-off state 6 in the general input data 10 and outputs corresponding state information as output data 20.

The hands-off state 6 is supplied in the form of a state signal or state information to a control unit 52 (FIG. 1) of the vehicle 50 for further processing. For example, the control unit 52 may be a transverse guidance assistance system or another assistance system. The state signal or state information can contain a hands-off probability or a binary state value with the two states “Hands-off recognized” and “Hands-off not recognized.”

The trained adapter model 5-2 may be selected as a function of the vehicle model, steering model, vehicle class, and/or at least one characteristic of the vehicle 50 (FIG. 1). This allows for selection of a suitable adapter model 5-2 for specific usage conditions.

The trained main model 5-1 may be provided in hard-coded form. For example, the main model 5-1 can be provided as an ASIC after training. The device 1 includes a corresponding memory 3-2 for this purpose.

The trained adapter model 5-2 may be stored in a writable non-volatile memory area reserved for this purpose (for example, in the memory 3-2). This allows the device 1 (FIG. 1) to be configured for various usage conditions after production. For instance, the device 1 can be part of a control unit or form a control unit, which is configured prior to installation in the vehicle 50 by storing an adapter model 5-2 tailored to the vehicle 50 in the memory area.

The trained main model 5-1 is configured and/or provided as a recurrent neural network. The recurrent neural network can be configured as a long short-term memory (LSTM).

The trained adapter model 5-2 may be configured and/or provided as a recurrent neural network, which can also be configured as a long short-term memory (LSTM). Alternatively, the trained adapter model can be a fully connected network or a convolutional neural network (CNN).

At least one piece of context information 7 may be detected and/or obtained, which is supplied as input data 11 to the trained adapter model 5-2. The trained adapter model 5-2 takes this context information 7 into consideration when determining the general input data 10.

FIG. 3 illustrates the training process for the adapter model 5-2. This training utilizes the previously fully trained main model 5-1, which remains fixed in terms of its parameters and weights. The training data consists of specific input data, particularly steering variable(s) 4 from a specific data domain for which the adapter model 5-2 is being trained. Each training datum pairs the steering variable(s) 4 with a ground truth 30 representing the actual hands-off state 6. In some examples, the training process follows these steps:
1. The steering variable(s) 4 are input to the untrained adapter model 5-2.
2. The adapter model 5-2 estimates general input data 10, which is then fed to the trained main model 5-1.
3. The main model 5-1 recognizes and outputs an estimated hands-off state 6.
4. This estimated state is compared to the ground truth 30, producing a deviation A.
5. The adapter model's parameters and weights are adjusted via back propagation based on this deviation.

This process repeats with additional training data until the deviation A falls below a predefined quality threshold. Once training is complete, the machine learning model 5 is ready for hands-off state recognition in a vehicle 50 (FIG. 1). In practical implementation, only the trained adapter model 5-2 may need to be loaded into a reserved memory area 3-2 in a pre-configured device 1 (e.g., part of a control unit). The trained main model 5-1 would typically already be stored in memory 3-2 or in a hard-coded form, as previously described.

### List of Reference Signs

1 device
2 steering variable sensor
3 data processing unit
3-1 computing unit
3-2 memory
4 steering variable
5 trained machine learning model
5-1 trained main model
5-2 trained adapter model
6 hands-off state
7 context information
10 general input data
11 specific input data
12 output layer
13 input layer
20 output data
30 basic truth
50 vehicle
51 steering wheel
52 control unit
60 steering system
Δ deviation

1. A method for recognizing a hands-off state at a steering wheel of a vehicle, the method comprising:
detecting at least one steering variable at the steering wheel;
supplying the detected at least one steering variable to a trained machine learning model as input data, wherein the machine learning model is trained to recognize a hands-off state based on at least the detected at least one steering variable, and to output an associated state information as output data;
wherein the trained machine learning model comprises a trained main model and a trained adapter model preceding the main model;
wherein the main model is trained to recognize the hands-off state based on general input data; and
wherein the adapter model is trained to determine the general input data based on vehicle-specific input data.

2. The method of claim 1, wherein the trained adapter model is selected as a function of at least one of a vehicle model of the vehicle, a steering model of the vehicle, a vehicle class, or at least one characteristic of the vehicle.

3. The method of claim 1, wherein the trained main model is provided in hard-coded form.

4. The method of claim 1, wherein the trained adapter model is stored in a writable non-volatile memory area reserved for this purpose.

5. The method of claim 1, wherein the trained main model is configured as a recurrent neural network.

6. The method of claim 1, wherein the trained adapter model is configured as a recurrent neural network.

7. The method of claim 1, further comprising:
detecting at least one piece of context information;
supplying the at least one piece of context information as input data to the trained adapter model; and
wherein the trained adapter model takes the at least one piece of context information into consideration during the determination of the general input data.

8. A device for recognizing a hands-off state at a steering wheel of a vehicle, comprising:
at least one steering variable sensor configured to detect at least one steering variable at the steering wheel; and
a data processing unit configured to:
receive the detected at least one steering variable,
provide a trained machine learning model,
supply the detected at least one steering variable to the trained machine learning model as input data,
wherein the machine learning model is trained to recognize a hands-off state based on at least the detected at least one steering variable, and to output associated state information as output data,
wherein the trained machine learning model comprises a trained main model and a trained adapter model preceding the main model,
wherein the main model is trained to recognize the hands-off state based on general input data, and
wherein the adapter model is trained to determine the general input data based on vehicle-specific input data.

9. The device of claim 8, wherein the trained adapter model is selected as a function of at least one of a vehicle model of the vehicle, a steering model of the vehicle, a vehicle class, or at least one characteristic of the vehicle.

10. The device of claim 8, wherein the trained main model is provided in hard-coded form.

11. The device of claim 8, wherein the trained adapter model is stored in a writable non-volatile memory area reserved for this purpose.

12. The device of claim 8, wherein the trained main model is configured as a recurrent neural network.

13. The device of claim 8, wherein the trained adapter model is configured as a recurrent neural network.

14. The device of claim 8, wherein the data processing unit is further configured to:
detect at least one piece of context information,
supply the at least one piece of context information as input data to the trained adapter model, and
wherein the trained adapter model takes the at least one piece of context information into consideration during the determination of the general input data.

15. A vehicle comprising:
a steering wheel;
at least one steering variable sensor configured to detect at least one steering variable at the steering wheel; and
a data processing unit configured to:
receive the detected at least one steering variable,
provide a trained machine learning model, and
supply the detected at least one steering variable to the trained machine learning model as input data,
wherein the machine learning model is trained to recognize a hands-off state based on at least the detected at least one steering variable, and to output associated state information as output data,
wherein the trained machine learning model comprises a trained main model and a trained adapter model preceding the main model,
wherein the main model is trained to recognize the hands-off state based on general input data, and
wherein the adapter model is trained to determine the general input data based on vehicle-specific input data.

16. The vehicle of claim 15, wherein:
the trained adapter model is selected as a function of at least one of a vehicle model of the vehicle, a steering model of the vehicle, a vehicle class, or at least one characteristic of the vehicle; or
the trained main model is provided in hard-coded form.

17. The vehicle of claim 15, wherein the trained adapter model is stored in a writable non-volatile memory area reserved for this purpose.

18. The vehicle of claim 15, wherein the trained main model is configured as a recurrent neural network.

19. The vehicle of claim 15, wherein the trained adapter model is configured as a recurrent neural network.

20. The vehicle of claim 15, wherein the data processing unit is further configured to:
detect at least one piece of context information,
supply the at least one piece of context information as input data to the trained adapter model, and
wherein the trained adapter model takes the at least one piece of context information into consideration during the determination of the general input data.
